(19) United States
(12) Patent Application Publication
(10) Pub. No.: US 2013/0219433 A1
(43) Pub. Date: Aug. 22, 2013

(54) ELECTRONIC APPARATUS AND SWITCHING METHOD

(71) Applicant: Takahiro Arai, Ome-shi (JP)

(72) Inventor: Takahiro Arai, Ome-shi (JP)

(21) Appl. No.: 13/692,548

(22) Filed: Dec. 3, 2012

(30) Foreign Application Priority Data
Feb. 20, 2012 (JP) 2012-034317

(51) Int. Cl. G06F 3/0488; H04N 21/422

(52) U.S. Cl. CPC G06F 3/0488; H04N 21/422
USPC 725/56

(57) ABSTRACT

According to one embodiment, an electronic apparatus includes an operation detection module, a first menu display module, a first instruction module, a second menu display module, and a second instruction module. The operation detection module detects first and second operation. The first and second menu display module display first and second menu on a display in accordance with the first and second operation. The first instruction module instructs display of content corresponding to a first display area displayed at a first predetermined position in the first menu. The second instruction module instructs display of content corresponding to a second display area displayed at a second predetermined position in the second menu.

### CROSS-REFERENCE TO RELATED APPLICATIONS

This application is based upon and claims the benefit of priority from Japanese Patent Application No. 2012-034317, filed Feb. 20, 2012, the entire contents of which are incorporated herein by reference.

### FIELD

Embodiments described herein relate generally to an electronic apparatus including a touch panel, a switching method.

### BACKGROUND

In recent years, various broadcasting services, such as ground-based broadcasting, BS (Broadcasting Satellite) broadcasting, CS (Communications Satellite) broadcasting and CATV (Cable Television) broadcasting, have been used. A viewer selects a desired channel from among many channels (programs) which are provided by various broadcast services, and can thus view a broadcast program of the selected channel.

In general, in many cases, the viewer's operation of selecting a channel is executed on a remote controller which is attached to a video apparatus such as a television apparatus. For example, one of the buttons on the remote controller is selected to directly switch the channel (program), or a channel up/down button is operated to switch the channel (program) in a predetermined order. In addition, by displaying a program list such as an electronic program guide and operating direction buttons on the remote controller, one of the programs in the program list can be selected.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating the external appearance of an electronic apparatus according to an embodiment.

FIG. 2 is an exemplary view illustrating the system configuration of a tablet computer in the embodiment.

FIG. 3 is an exemplary flow chart illustrating a channel switching process in the embodiment.

FIG. 4 is an exemplary flow chart illustrating the channel switching process in the embodiment.

FIG. 5 is an exemplary flow chart illustrating a channel menu movement process in the embodiment.

FIG. 6 is a view illustrating an example of a channel menu which is displayed on the screen in the embodiment.

FIG. 7 is an exemplary view illustrating a state in which a display position of each display area of the channel menu in the embodiment is changed.

FIG. 8 is an exemplary view illustrating a state in which a display position of each display area of the channel menu in the embodiment is changed.

FIG. 9 is an exemplary view for describing a position of a display area, which varies in accordance with a movement distance of a touch position in the embodiment.

FIG. 10 is an exemplary view for explaining alignment of a display area in the embodiment.

FIG. 11 is an exemplary view for describing the position of a display area which varies in accordance with a movement velocity of a touch position by a flick operation in the embodiment.

FIG. 12 is a view illustrating an example of a channel menu which is provided with a display area corresponding to a multi-channel in the embodiment.

FIG. 13 is a view illustrating an example of a screen which is displayed in accordance with an input operation in the embodiment.

FIG. 14 is a view illustrating an example of the screen which is displayed in accordance with an input operation in the embodiment.

FIG. 15 is a view illustrating an example of the screen which is displayed in accordance with an input operation in the embodiment.

FIG. 16 is a view illustrating a display example of the channel menu in the embodiment.

FIG. 17 is a view illustrating a display example of the channel menu in the embodiment.

FIG. 18 is a view illustrating a display example of the channel menu in the embodiment.

### DETAILED DESCRIPTION

Various embodiments will be described hereinafter with reference to the accompanying drawings.

In general, according to one embodiment, an electronic apparatus comprises a tablet, a display, an operation detection module, a first menu display module, a first instruction module, a second menu display module, and a second instruction module. The operation detection module is configured to detect a first operation of releasing a touch on the tablet after moving a first touch position, and a second operation of releasing a touch on the tablet while moving a second touch position at a predetermined velocity or more. The first menu display module is configured to display a first menu on the display in accordance with the first touch position, the first menu comprising display areas displaying information of content, and to change display positions of the display areas in accordance with a movement distance of the first touch position. The first instruction module is configured to instruct, responding to the first operation of releasing the touch on the tablet, display of content corresponding to a first display area displayed at a first predetermined position in the first menu, among the display areas. The second menu display module is configured to display a second menu in accordance with the second touch position, and to change the display positions of the display areas in accordance with a movement velocity of the second touch position. The second instruction module is configured to instruct display of content corresponding to a second display area displayed at a second predetermined position in the second menu, among the display areas.

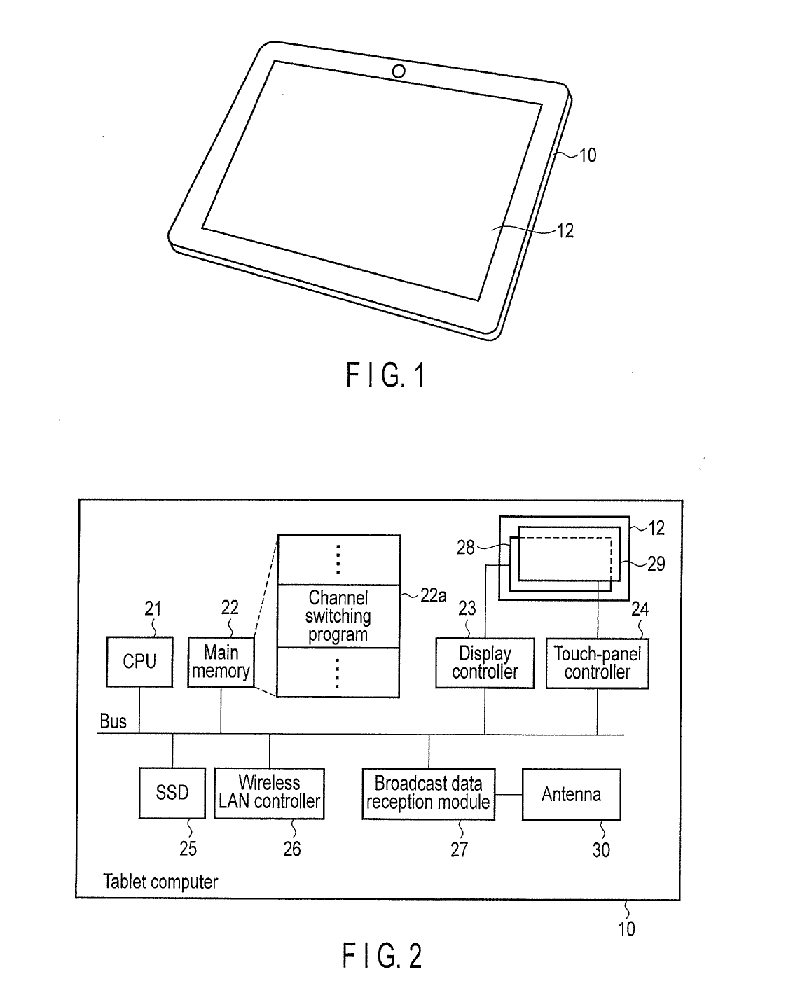

FIG. 1 is an exemplary view illustrating the external appearance of an electronic apparatus according to an embodiment. The electronic apparatus is realized, for example, as a tablet computer 10 which can be driven by a battery.

A touch-screen display 12 is built in the housing of the tablet computer 10. The touch-screen display 12 is composed of a touch panel and a liquid crystal display (LCD), and a display screen is located at a substantially central part of the housing.

The touch-screen display 12 is configured, for example, such that the touch panel is attached to the surface of the LCD, and it is possible to realize display by the LCD and detection of a touch position which is touched by a pen or a fingertip. A user can directly select various objects displayed on the LCD, by using the fingertip or pen. In addition, the user can perform an input operation, such as a tap, slide or flick, on the touch-screen display 12. The tablet computer 12 can execute a process in accordance with a difference between input operations by the user.

Although not shown, the tablet computer 10 is provided with a power button for switching power on/off, a media slot in which a recording medium can be detachably inserted, and a terminal for connection to a peripheral device or a cable.

FIG. 2 is an exemplary view illustrating the system configuration of the tablet computer 10 in the embodiment.

The tablet computer 10 includes a CPU 21, a main memory 22, a display controller 23, a touch-panel controller 24, a solid-state drive (SSD) 25, a wireless LAN controller 26, a display 28, a touch panel 29, and an antenna 30.

The CPU 21 is a processor which controls the respective components of the tablet computer 10. The CPU 21 executes various programs which are loaded from the SSD 25 into the main memory 22. The various programs include a television (TV) application program, as well as an OS (Operating System). The TV application program provides a TV viewing function for viewing TV broadcast. The TV application program executes a process for outputting video/audio of a broadcast program, based on broadcast program data of a channel of a target of viewing, which has been received by a broadcast data reception module 27. The TV application program includes a channel switching program 22a. The channel switching program 22a executes a channel switching process for switching the viewing-target channel in accordance with a user operation.

The display controller 23 generates a display signal which is to be displayed on the touch-screen display 12. The touch-screen display 12 is composed of, for example, the liquid crystal display 28 and the touch panel 29 that is disposed on the liquid crystal display 28. The touch panel 29 detects a touch (physical contact) on the surface thereof by a fingertip or a pen tip, and outputs data indicative of a touch position (coordinates).

The touch panel controller 24 notifies the CPU 21 of the data which has been output from the touch panel 29.

The wireless LAN controller 26 executes wireless communication with other electronic apparatuses, based on, e.g. IEEE 802.11 standards. The other electronic apparatuses, with which the wireless LAN controller 26 executes wireless communication, include, for example, a television (TV) apparatus.

The broadcast data reception module 27 is configured to receive broadcast program data via the antenna 30. The broadcast data reception module 27 may include a plurality of tuners corresponding to a plurality of kinds of broadcast waves (ground-based broadcasting, BS broadcasting, CS broadcasting, etc.). The broadcast data reception module 27 is configured to select (“channel switching”) an arbitrary viewing-target channel from a plurality of receivable channels, under the control of the CPU 21.

Although not shown, the tablet computer 10 is provided with a speaker which produces sound, or a headphone terminal for outputting an audio signal.

Next, the operation of the tablet computer 10 in the embodiment is described.

The tablet computer 10 executes the TV application program by the CPU 21, thereby receiving broadcast data by the broadcast data reception module 27 and displaying video of a TV broadcast program on the touch-screen display 12 (display 28). While the TV broadcast is being viewed, the tablet computer 10 provides a channel menu for switching the channel in accordance with a user operation on the touch-screen display 12, and accepts an instruction of channel switching. In a channel switching process of the embodiment, a switching to a neighboring channel and a direct switching to a desired channel are realized by a consecutive operation with use of a common menu. The consecutive operation is a series of operations, such as touching the touch-screen display 12, then moving the touch position while keeping the touched state, and then releasing the touch position.

In the input operation for the direct switching to a desired channel, it is assumed that use is made of an operation (hereinafter referred to as “slide operation”) of moving a touch position to a target channel and then releasing the touch position. In the input operation for the switching to a neighboring channel, it is assumed that use is made of an operation (hereinafter “flick operation”) of moving a touch position toward a target channel at a velocity higher than a predetermined velocity and releasing the touch position while moving the touch position.

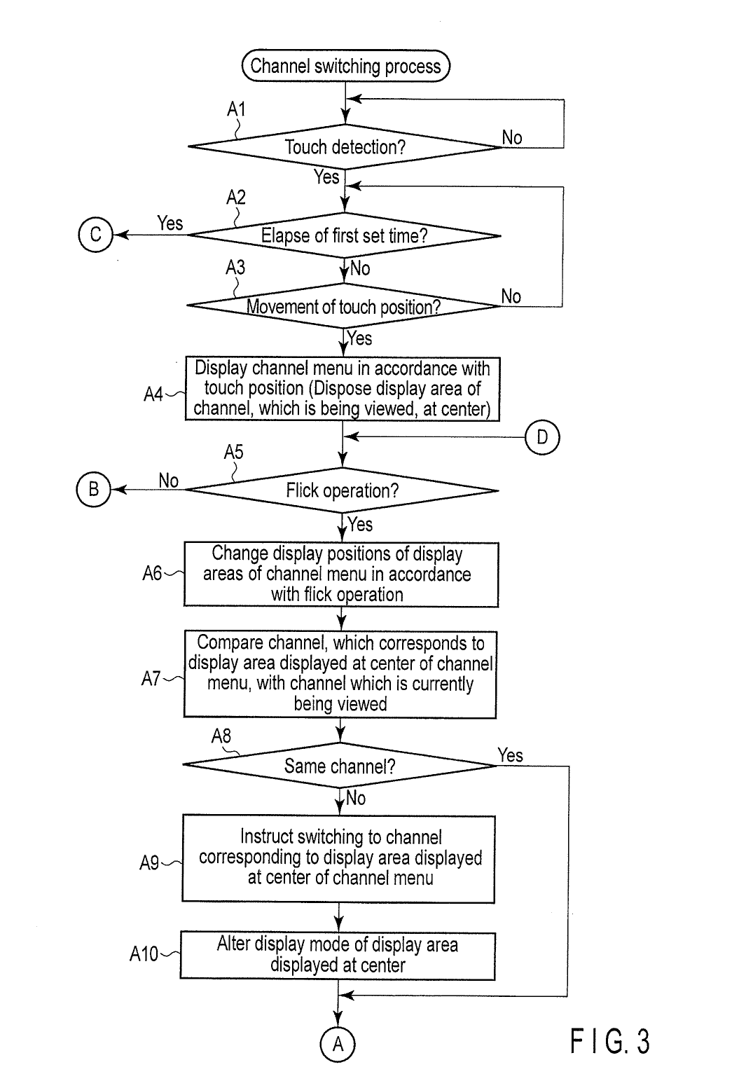

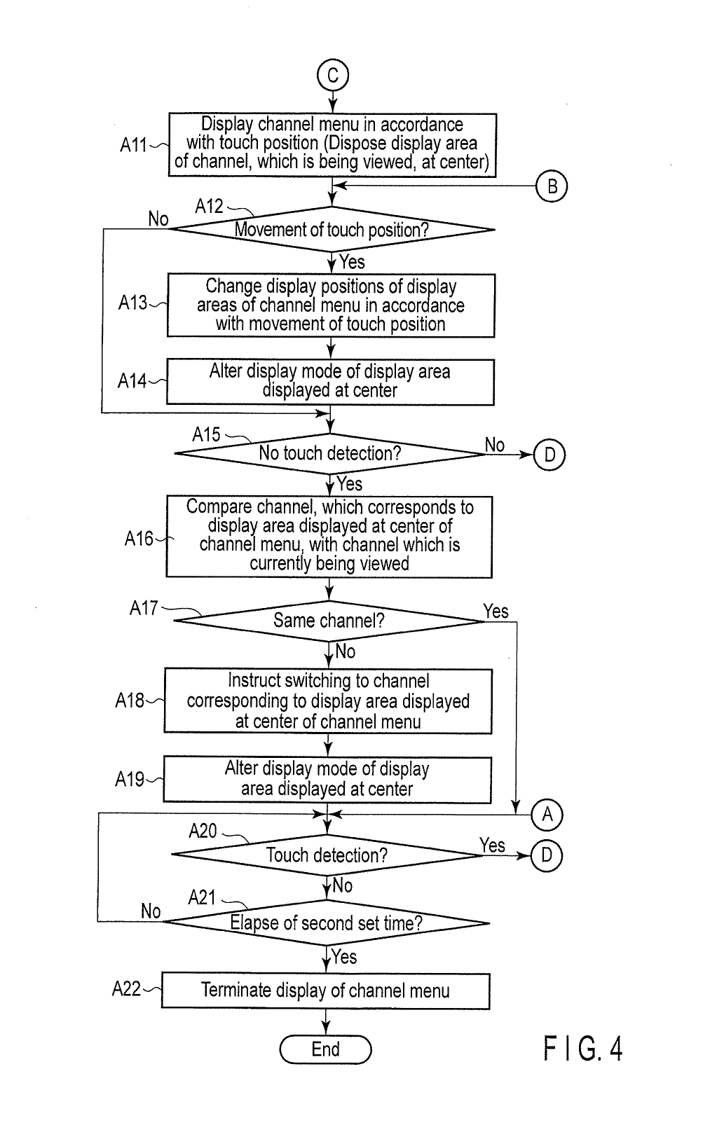

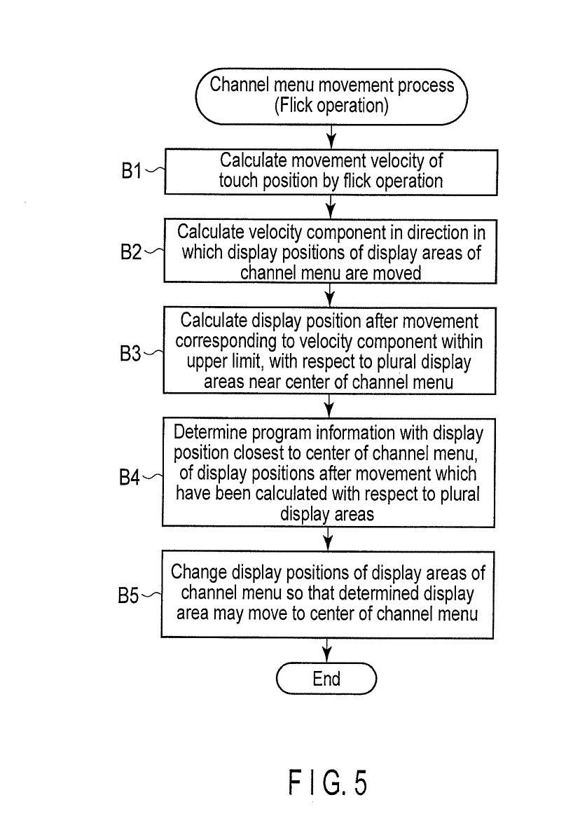

Next, the channel switching process in the embodiment is described with reference to flow charts. FIG. 3 and FIG. 4 are flow charts illustrating the channel switching process which is executed by the channel switching program 22a in the embodiment, and FIG. 5 is a flow chart illustrating a channel menu movement process in the channel switching process in the embodiment.

While a TV broadcast program is being displayed on the touch-screen display 12, if the CPU 21 detects, based on data from the touch-panel controller 24, that the touch-screen display 12 has been touched (Yes in block A1), the CPU 21 starts measuring an elapsed time from the detection of touch.

Before a predetermined first set time has passed (No in block A2), if a movement of the touch position is detected (Yes in block A3), the CPU 21 causes the touch-screen display 12 (display 28) to display a channel menu at a predetermined position (block A4). In the determination of the movement of the touch position, it is determined whether or not the touch position has moved over a predetermined short distance from the first touch position. In addition, it is assumed that the channel menu is displayed when any position on the touch-screen display has been touched.

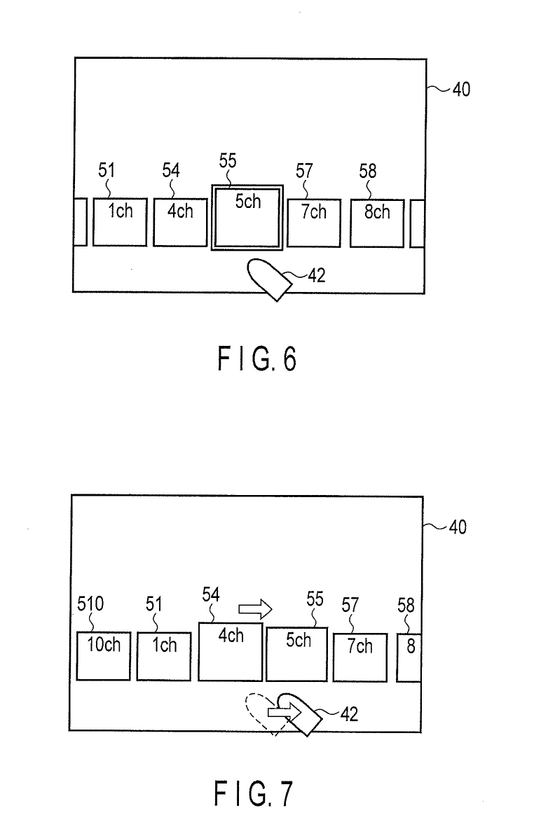

FIG. 6 is a view illustrating an example of the channel menu which is displayed on a screen 40.

As shown in FIG. 6, the channel menu is displayed, for example, in the vicinity of a lower side of the screen 40. The channel menu is configured such that a plurality of display areas 51, 54, 55, 57 and 58, in which channel (content) information corresponding to a plurality of channels is displayed, are linearly arranged in a predetermined direction. In the channel menu shown in FIG. 6, the plural display areas 51, 54, 55, 57 and 58 are horizontally arranged in a strip shape.

The information (program information), which is displayed in the display areas 51, 54, 55, 57 and 58, is, for instance, channel numbers, as shown in FIG. 6. In addition to the channel numbers, the names of broadcast stations, the logos of broadcast stations, the titles of programs and images relating to programs may be displayed in combination. Furthermore, when broadcast program data of a plurality of channels can be received at the same time by the broadcast data reception module 27, it may be possible to generate thumbnails which are to be displayed in the display areas of the channel menu, based on the broadcast program data of channels other than the channel which is being currently viewed, and to display the thumbnails in the display areas corresponding to the respective channels.

In the channel menu, the display area corresponding to the channel, which is being currently viewed, is displayed at the center. In addition, the display area, which is displayed at the center, is displayed in a special display mode, which is different from the display mode of the other display areas, thereby to demonstrate that the display area displayed at the center is the display area of the channel that is currently selected as the target of viewing. For example, the size of this display area may be made larger than the size of each of the other display areas, or this display area may be displayed with a different color, different brightness or different shape.

In the meantime, the position of the display area of the channel, which is selected as the target of viewing, may not be at the center of the channel menu. By displaying this display area in a special display mode, the user can recognize that the display area is that of the channel which is selected as the target of viewing, even if the display area is not located at the center of the channel menu.

In the case where the input operation on the touch-screen display 12 is not a flick operation (No in block A5), if the touch position is moved while the touched state is being kept (Yes in block A12), the CPU 21 changes, in accordance with the movement of the touch position, the position of the display area which displays each program information of the channel menu (block A13). In addition, the CPU 21 changes the display mode of the display area which is displayed at the center of the channel menu (block A14).

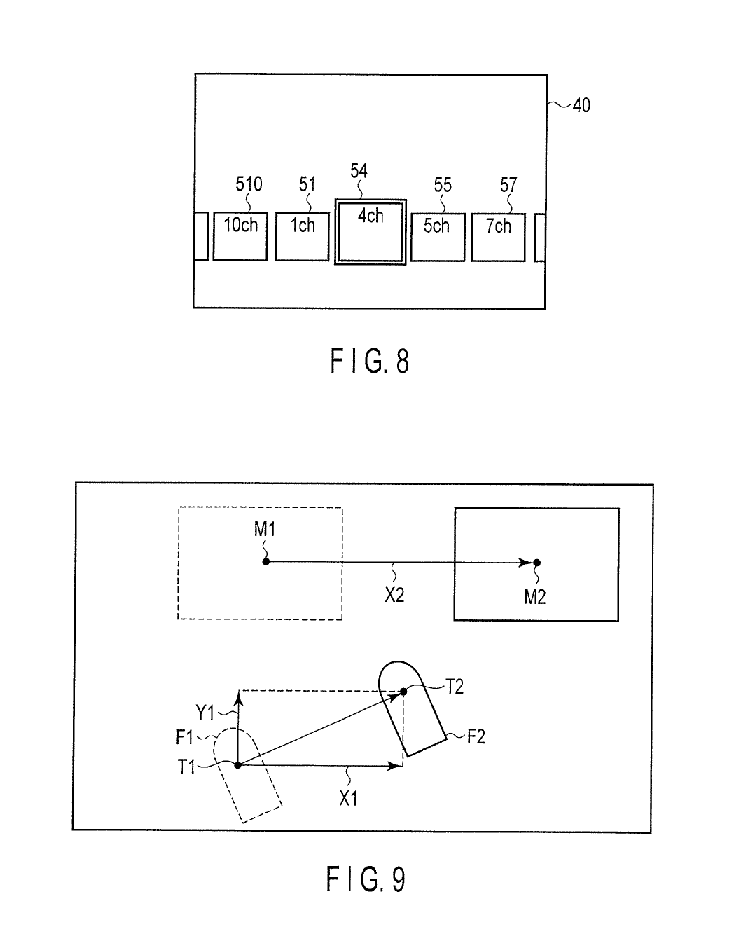

FIG. 7 and FIG. 8 illustrate a state in which the display position of each display area 51, 54, 55, 57, 58, 510 is changed in accordance with the movement of a touch position 42. As shown in FIG. 7, since the touch position 42 is moved rightward, the display positions of the display areas 51, 54, 55, 57 and 58 are shifted rightward. In addition, as shown in FIG. 8, when the display area 54 corresponding to “4ch” is moved to the center of the channel menu, the display mode of the display area 54 is changed.

In the channel menu shown in FIG. 6, FIG. 7 and FIG. 8, seven display areas corresponding to seven channels (“1ch”, “4ch”, “5ch”, “7ch”, “8ch”, “9ch” and “10ch”) are arranged in a predetermined order. The screen 40 does not display the display areas corresponding to all channels. Thus, in accordance with the change of display of the channel menu, a display area, which was not displayed before the change of display, is newly displayed according to the order of arrangement. In FIG. 7, in accordance with the rightward movement of the respective display areas of the channel menu, a display area 510 corresponding to “10ch”, which is disposed next to “1ch”, is added from the left side of the screen 40.

In the meantime, the change of the display mode of the display area is not limited to the case of changing the display mode of only the display area that is located at the center of the channel menu. As shown in FIG. 7, as regards a display area which is near the center of the channel menu, the display mode can be changed in accordance with the distance from the center, which varies in accordance with the movement of the display area. For example, the display size of the display area 54 corresponding to “4ch” is gradually increased as the display area 54 moves closer to the center. In addition, the display size of the display area 55 corresponding to “5ch” is gradually decreased as the display area 55 moves away from the center.

Thereby, since the display mode gradually changes as the display area moves closer to the center in accordance with the movement of the touch position 42, the display area of a channel, which is to be next selected as the target of viewing, can easily be recognized.

FIG. 9 is an exemplary view for describing the position of the display area, which varies in accordance with a movement distance of the touch position 42.

In FIG. 9, it is assumed that a touch position has been moved from a first touch position F1 to a touch position F2 while the touched state of the touch position is being kept. Specifically, the touch position is moved in an oblique direction, unlike the direction of movement of the display areas of the channel menu.

Based on a movement distance T1-T2 from the touch position F1 to touch position F2, the CPU 21 calculates a movement distance X1 in a direction (X-axis direction) in which the display area of the channel menu is to be moved. The CPU 21 calculates a movement distance X2 of the display area, which corresponds to the movement distance X1. In this case, as shown in FIG. 9, the movement distance X1 of the touch position is not equal to the movement distance X2 of the display area, and it is preferable to set X1<X2. Thereby, since each display area of the channel menu can be moved over a longer distance than the movement distance of the touch position, the display area of a viewing-target channel, among a plurality of channels, can be easily moved to the center of the channel menu.

In this manner, if the touch-screen display 12 remains in the touched state, the display position of each display area of the channel menu can be moved by moving the touch position in accordance with the direction of movement of the touch position. Thus, a desired channel, among a plurality of channels, can be directly moved to the center of the channel menu and can be selected as the viewing-target channel.

If the CPU 21 detects that the touch on the touch-screen display 12 has been released (Yes in block A15), the CPU 21 starts measuring an elapsed time from the release of the touch. Specifically, the CPU 21 measures an elapsed time from the end of the input operation on the channel menu. Incidentally, when the touch on the touch-screen display 12 is released, it is assumed that a flick operation (i.e. an operation of moving a touch position at a higher velocity than a predetermined velocity and releasing the touch position while moving the touch position) is not performed. The case in which the touch is released by a flick operation will be described later (blocks A5 to A10).

The CPU 21 executes final alignment of each display area, based on the position of each display area at a time when the touch on the touch-screen display 12 has been released. In this case, the CPU 21 aligns the display area, which has been moved to a position closest to the center of the channel menu, at a predetermined central position.

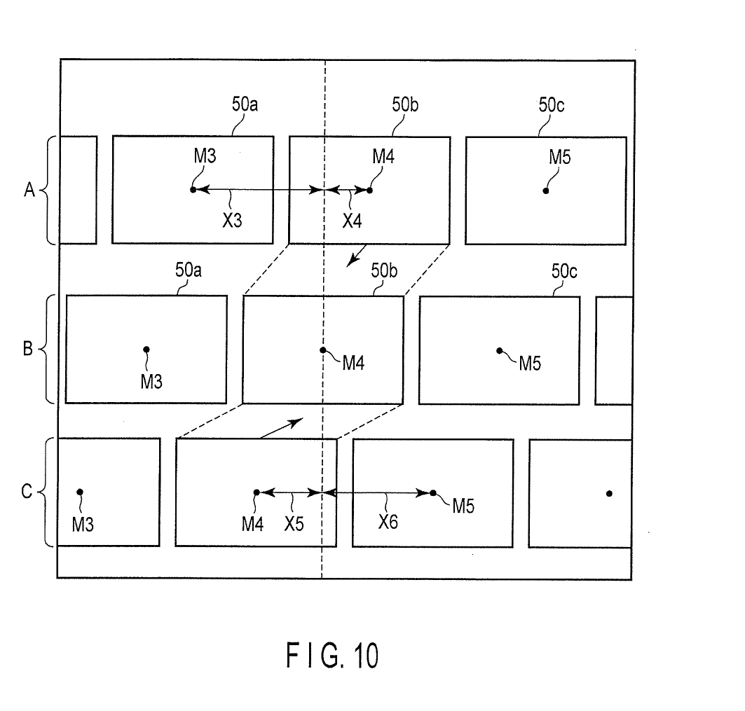

FIG. 10 is an exemplary view for explaining the alignment of the display area.

As shown in part A of FIG. 10, it is assumed that when a touch on the touch-screen display 12 has been released, display areas 50a and 50b are disposed in the vicinity of a central position (indicated by a broken line) of the channel menu. In this case, the CPU 21 compares a distance X3 between a position M3 of the display area 50a and the central position and a distance X4 between a position M4 of the display area 50b and the central position, and discriminates the display area which is closer to the central position. In the example shown in part A of FIG. 10, the display area 50b is closer to the central position. Thus, as shown in part B of FIG. 10, the display area 50b is aligned at the central position.

In the case of part C of FIG. 10, a distance X5 between the position M4 of the display area 50b and the central position is compared with a distance X6 between a position M5 of the display area 50c and the central distance. As a result, it is determined that the display area 50b is closer to the central position. Thus, as shown in part B of FIG. 10, the display area 50b is aligned at the central position.

Next, the CPU 21 compares the channel corresponding to the display area, which is disposed at the center of the channel menu, and the channel which is being currently viewed (block A16).

If these channels are not the same (No in block A17), the CPU 21 instructs the broadcast data reception module 27 to switch to the channel corresponding to the display area which is disposed at the center of the channel menu. Based on the broadcast data after the channel switching, which has been received by the broadcast data reception module 27, the CPU 21 displays video of a TV broadcast program on the touch-screen display 12 (display 28). At this time, the channel menu is kept in the displayed state.

On the other hand, when the channels are the same (Yes in block A17), the CPU 21 does not instruct the switching to the channel. Specifically, when the channel menu is operated by the user and the channel, which is being currently viewed, is finally selected, a process for channel switching is not caused to occur.

The CPU 21 causes the display area, which is disposed at the center of the channel menu, to be displayed in such a display mode as to demonstrate that this display area has been selected as the display area of the viewing-target channel (block A19). For example, the display area is instantaneously brightened, or the size of the display area is increased. Thereby, the user can confirm the channel which has been switched by the operation on the channel menu.

Until the passing of a predetermined second set time (e.g. 5 seconds) from the end of the input operation on the channel menu, the channel menu is displayed as such (blocks A20 and A21). If the CPU 21 detects that the touch-screen display 12 has been touched once again while the channel menu is being displayed (Yes in block A20), the CPU 21 changes the position of the display area of the channel menu in accordance with a movement of the touch position or a flick operation (to be described later). Specifically, the CPU 21 enables continuous execution of a user operation for channel selection using the channel menu.

On the other hand, if no touch is detected (No in block A20) and the second set time has passed (Yes in block A21), the CPU 21 turns off the display of the channel menu and terminates the channel switching process (block A22).

In the meantime, when the input operation on the touch-screen display 12 is a flick operation (Yes in block A5), the CPU 21 changes the position of the display area, which displays each program information of the channel menu, by a channel menu movement process (to be described later) in accordance with the flick operation (block A6). Specifically, in accordance with the velocity of movement of the touch position by the flick operation, the CPU 21 changes the position of each display area of the channel menu. However, an upper limit is set to the movement velocity of the touch position by the flick operation (or a velocity component in the direction of movement of the display area of the channel menu), and thereby the distance of movement of the display area is limited. In this case, when a flick operation for moving the touch position has been executed at a movement velocity of the upper limit or higher, the display area that is disposed at the center of the channel menu is changed to a neighboring display area. Specifically, by the flick operation, the current viewing-target channel is switched to the next channel in the order of arrangement of display areas in the channel menu.

Incidentally, the upper limit to the movement velocity may not only be set such that the display area at the center is changed to the neighboring display area by a single flick operation. However, the upper limit may also be set such that the display area is changed to, for example, every other display area.

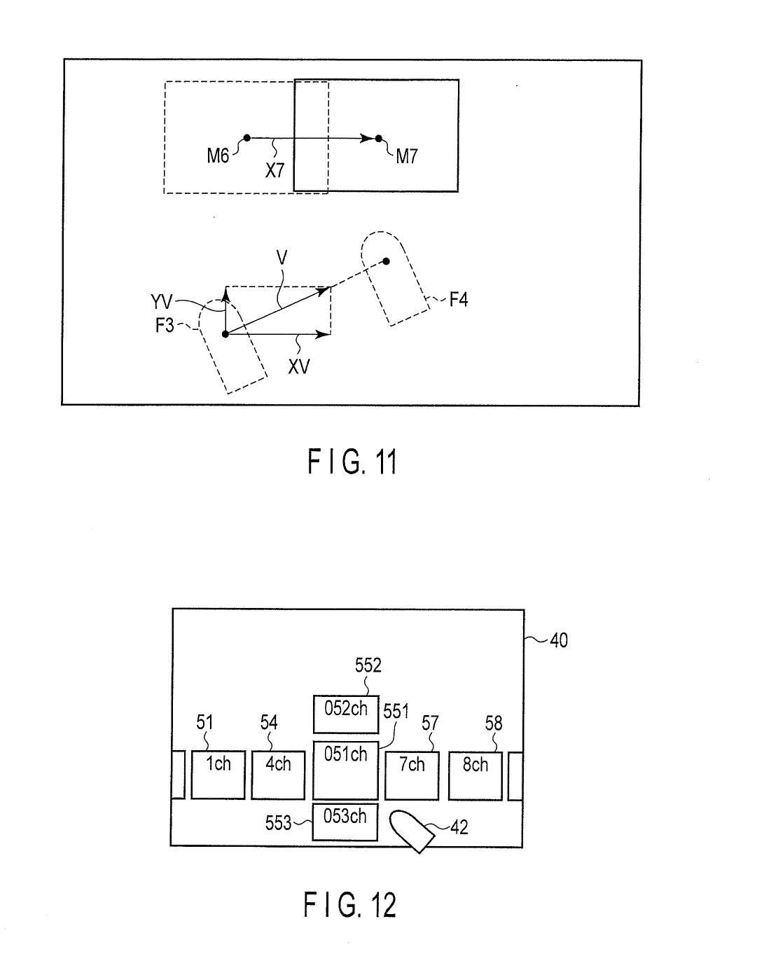

FIG. 5 is an exemplary flow chart illustrating a channel menu movement process for changing the position of the display area at a time of a flick operation. FIG. 11 is an exemplary view for describing the position of the display area which varies in accordance with the movement velocity of the touch position by the flick operation.

To start with, the CPU 21 calculates the movement velocity of the touch position by the flick operation (block B1).

In FIG. 11, it is assumed that a touch position was moved from a first touch position F3 to a touch position F4 at a velocity V while the touched state of the touch position was being kept, and then the touch has been released. Specifically, the flick operation is executed in an oblique direction, unlike the direction of movement of the display areas of the channel menu.

Based on the velocity V in the direction of the flick operation, the CPU 21 calculates a velocity component XV in the movement direction (X-axis direction) of the display area of the channel menu (block B2). It is assumed that the velocity component XV is such a value that a velocity of a predetermined upper limit or higher is disregarded. In addition, there is a case in which when a flick operation of slowly moving the touch position has been executed, the velocity component V does not reach the upper limit. As shown in FIG. 11, in accordance with the velocity component XV, the CPU 21 calculates a distance X7 between a position M6 of the display area before movement and a position M7 of the display area after movement.

The CPU 21 calculates the display position after movement, which corresponds to the velocity component within the upper limit, with respect to each of the plural display areas which are in the vicinity of the center of the channel menu (block B3). The CPU 21 determines the display area whose display position after movement is closest to the center of the channel menu, of all the calculated display positions after movement of the plural display areas (block B4).

For example, when the respective display areas have been moved in accordance with the distance X7, any one of the display areas is not necessarily disposed at the center of the channel menu. For example, when the display areas are moved in accordance with the distance X7, there is a case such as the display area 50b shown in part A of FIG. 10 or the display area 50b shown in part C of FIG. 10. Based on imaginary positions of plural display areas in the vicinity of the center of the channel menu, which are moved in accordance with the distance X7, the CPU 21 determines the display area which is to be finally disposed at the center of the channel menu. For example, as shown in part A of FIG. 10 or part C of FIG. 10, the display area 50b with a shortest distance from the center of the channel menu is determined to be the display area which is to be finally disposed at the center of the channel menu.

The CPU 21 changes the display positions of the respective display areas so that the display area, which has been determined to be finally disposed at the center of the channel menu, may move from the present position to the center of the channel menu. For example, the display area 50b, which is displayed at the position shown in part C of FIG. 10, is displayed such that the display 50b is moved to the center of the channel menu and is then stopped, as shown in part B of FIG. 10.

Next, the CPU 21 compares the channel corresponding to the display area, which is disposed at the center of the channel menu, and the channel which is being currently viewed (block A7).

If these channels are not the same (No in block A8), the CPU 21 instructs the broadcast data reception module 27 to switch to the channel corresponding to the display area which is disposed at the center of the channel menu. Based on the broadcast data after the channel switching, which has been received by the broadcast data reception module 27, the CPU 21 displays video of a TV broadcast program on the touch-screen display 12 (display 28). At this time, the channel menu is kept in the displayed state.

On the other hand, when the channels are the same (Yes in block A8), the CPU 21 does not instruct the switching to the channel. Specifically, when the channel menu is operated by the user and the channel, which is being currently viewed, is finally selected, a process for channel switching is not caused to occur.

The CPU 21 causes the display area, which is disposed at the center of the channel menu, to be displayed in such a display mode as to demonstrate that this display area has been selected as the display area of the viewing-target channel (block A10). For example, the display area is instantaneously brightened, or the size of the display area is increased. Thereby, the user can confirm the channel which has been switched by the operation on the channel menu.

In the case where the channel menu was displayed by the flick operation, until the passing of the predetermined second set time (e.g. 5 seconds) from the end of the input operation, the channel menu is displayed as such (blocks A20 and A21). If the CPU 21 detects that the touch-screen display 12 has been touched once again while the channel menu is being displayed (Yes in block A20), the CPU 21 changes the position of the display area of the channel menu in accordance with a movement of the touch position or a flick operation. Specifically, the CPU 21 enables continuous execution of a user operation for channel selection using the channel menu. Accordingly, when the TV broadcast program is to be displayed by successively switching a plurality of channels in order, it should suffice if the flick operation is repeated.

On the other hand, if no touch is detected (No in block A20) and the second set time has passed (Yes in block A21), the CPU 21 terminates the display of the channel menu and terminates the channel switching process (block A22).

In the meantime, after the first touch detection (Yes in block A1), if the preset first set time has passed in the state in which the touch position is not moved (Yes in block A2), the CPU 21 causes the touch-screen display 12 (display 28) to display the channel menu at a predetermined position (block A11).

Then, as described above, in accordance with a slide operation or a flick operation, the positions of the respective display areas of the channel menu are moved, and the user is prompted to select the channel that is the target of viewing.

In this manner, in the tablet computer 10 in the embodiment, the viewing-target channel can be selected by using the common channel menu by a slide operation or a flick operation. By executing a slide operation on the channel menu, a desired channel can directly be selected from among a plurality of channels. In addition, by executing a flick operation on the channel menu, switching can be effected to a channel next to the channel that is being currently viewed. Each of the slide operation and the flick operation is such an operation that the touch-screen display 12 is touched, the touch position is moved, and then the touch position is released. Thus, it is possible to execute, by the consecutive input operation, the channel switching for directly selecting a channel and the channel switching for successively switching channels in a predetermined order. In addition, since the transition until the completion of channel switching is reflected on the display of the channel menu, the user can confirm that the switching to a target channel has been effected and the user is given a sense of assurance.

In addition, in the channel switching process in the embodiment, the channel corresponding to the display area, which is disposed at a predetermined position (e.g. central position) of the channel menu at a time when the touch is released after executing the input operation for changing the position of the display area of the channel menu, is determined to be the viewing-target channel. Thus, after executing the operation of changing the position of the display area that is displayed on the channel menu, there is no need to additionally execute an operation such as selecting a display area. Therefore, the operation for channel switching becomes easy, and the channel switching can be effected by only an intuitive input operation.

In the above description, the case is presupposed that one TV broadcast program is broadcast on one channel. However, there is broadcast by so-called “multi-channel”, in which a plurality of TV broadcast programs are broadcast on one channel. In the channel switching process of the embodiment, a display area corresponding to a multi-channel is provided on the channel menu, and an input operation for selecting a viewing-target channel from the multi-channel can be determined.

FIG. 12 illustrates an example of a channel menu which is provided with a display area corresponding to a multi-channel.

In FIG. 12, it is assumed that “5ch”, which corresponds to a display area disposed at the center of the channel menu, is a multi-channel. The display area corresponding to “5ch” is displayed as one display area, as shown in FIG. 8, when this area is not disposed at the center of the channel menu.

When the display area corresponding to “5ch” has been moved to the center of the channel menu, display areas corresponding to respective channels of the multi-channel are displayed, as shown in FIG. 12. In the example shown in FIG. 12, “5ch” includes three channels, i.e. “051ch”, “052ch” and “053ch”, and display areas 551, 552 and 553 corresponding to these channels are provided. Since the display areas 51, 54, 57 and 58 of the channel menu are arranged in the horizontal direction, the display areas 551, 552 and 553 are arranged in a direction different from the horizontal direction. In FIG. 12, the display areas of the multi-channel are vertically arranged. However, if the multi-channel is discriminable, the display areas of the multi-channel may be arranged, for example, in an oblique direction.

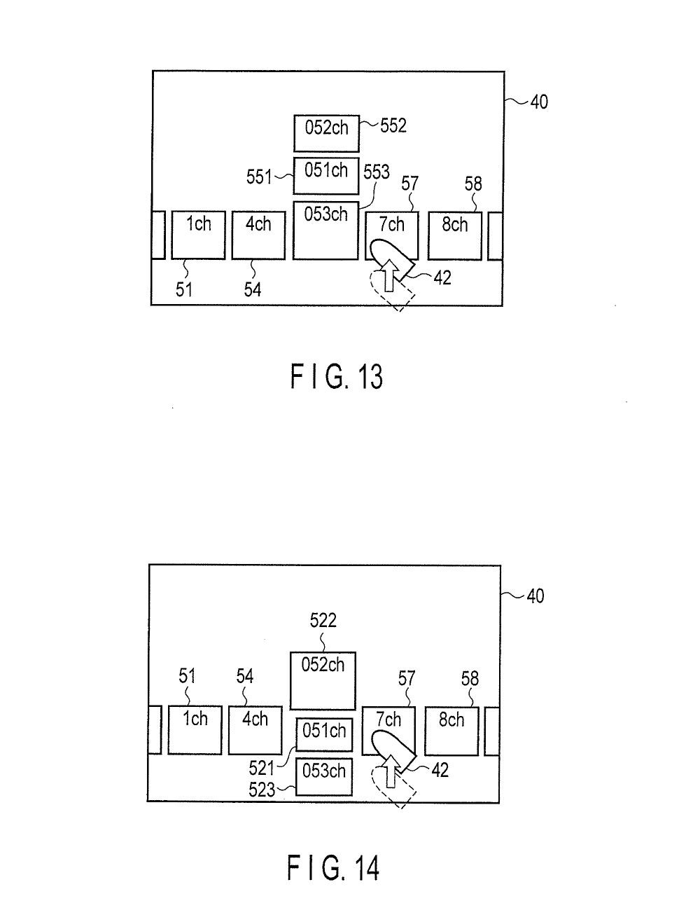

In the case where the display areas 551, 552 and 553 of the multi-channel are vertically arranged, such configuration is adopted that a display area corresponding to a viewing-target channel can be selected by a vertical input operation (a touch position moving operation). For example, as shown in FIG. 13, when an input operation of moving the touch position 42 upward has been executed (slide operation or flick operation), the CPU 21 moves the display positions of the vertically arranged display areas 551, 552 and 553 in accordance with the movement of the touch position 42. Then, the display area 553, which has been moved to the center of the channel menu, is set as the target of selection, and the display mode of the display area 553 is altered. In this case, by releasing the touch, the channel is switched to “053ch”.

As shown in FIG. 14, such configuration may be adopted that a display area arranged in the direction of an input operation can be selected, with the display positions of the display areas 551, 552 and 553 of the multi-channel being unchanged. As shown in FIG. 14, when an input operation for upward movement has been executed, the display area 522, which corresponds to “052ch” disposed on the upper side, is set as the target of selection, and the display mode of the display 522 is altered. In this case, by releasing the touch, the channel is switched to “052ch”.

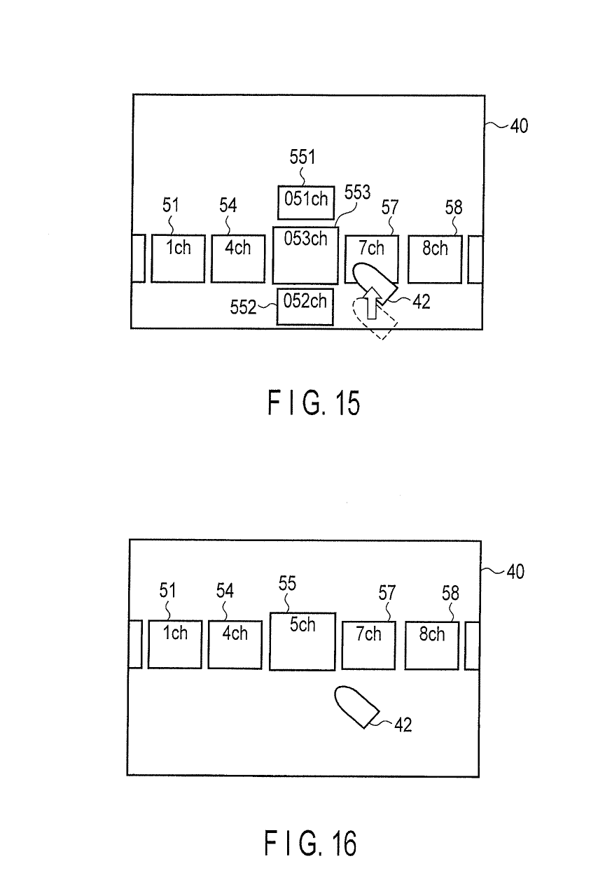

Besides, such configuration may be adopted that the display area, which is disposed at the center of the channel menu, is changed in the order of arrangement of the display areas 551, 552 and 553, as shown in FIG. 14. For example, when the touch position 42 is moved upward in the state in which the display area 551 of “051ch” is disposed at the center, as shown in FIG. 12, the display area 553 corresponding to “053ch”, which is arranged below the display area 551 of “051ch”, is moved upward and disposed at the center, as shown in FIG. 15. The display area 552 corresponding to “052ch”, which is arranged above the display area 551 of “051ch” in FIG. 12, is moved upward from the lower side of the screen 40, as shown in FIG. 15. In this case, by releasing the touch, the channel is switched to “053ch”.

In this manner, in the case of the multi-channel, too, the channel switching can be effected by a consecutive input operation, with only the direction of movement of the touch position being different from the direction of movement in the case of changing the display positions of the display areas 51, 54, 57 and 58 corresponding to channels which are not the multi-channel.

In the above description, the channel menu is displayed at a predetermined position of the screen 40 (e.g. in the vicinity of the lower side of the screen 40). Alternatively, the display position of the channel menu may be determined in accordance with the first touch position. For example, as shown in FIG. 16, when the first touch position 42 is in the vicinity of the center of the screen 40 (touch-screen display 12), the CPU 21 causes the channel menu to be displayed near the first touch position 42. In this case, it is preferable that the channel menu be disposed on an upper side of the touch position 42 in the screen 40. Specifically, by disposing the channel menu on the upper side of the touch position 42, it becomes possible to prevent the channel menu from being hidden by, for example, the fingertip touching the screen 40.

Furthermore, the display position of the display area of the channel, which has been selected as the target of viewing, may be disposed near the first touch position 42.

In this manner, by disposing the channel menu near the first touch position, the operation on the channel menu may be made easier.

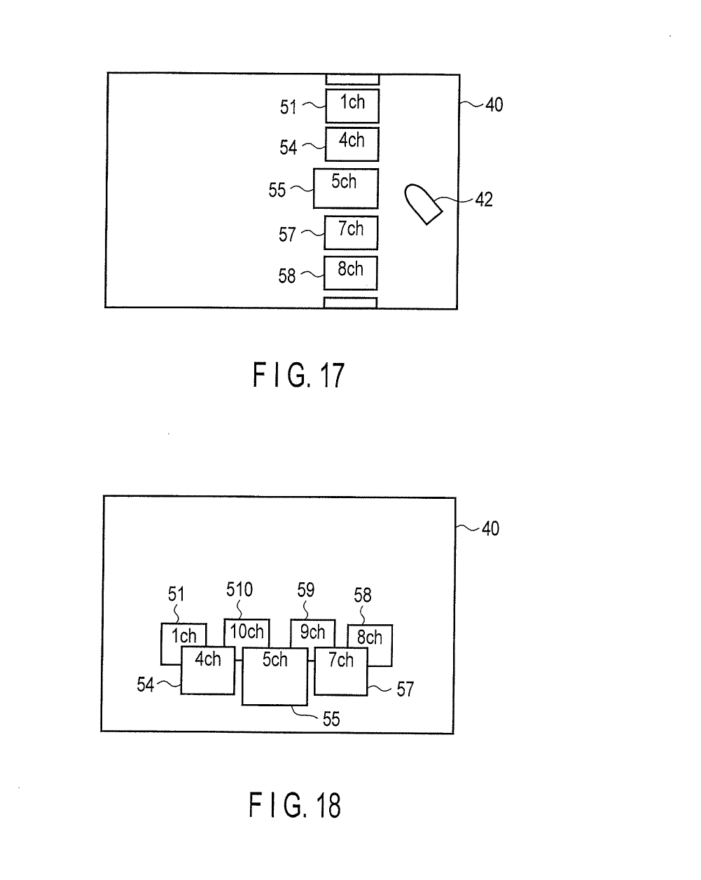

The above-described channel menu is configured such that a plurality of display areas are horizontally arranged. Alternatively, as shown in FIG. 17, the channel menu may be configured such that a plurality of display areas are vertically arranged. In the channel menu in which the display areas are vertically arranged, the display position of each display area is moved in accordance with a movement distance (distance Y1 in FIG. 9) in the vertical direction (Y-axis direction) of the touch position 42.

In the example illustrated in FIG. 17, the first touch position 42 is near the right side of the screen 40. Thus, the channel menu, which is vertically arranged, is displayed on the left side of the touch position 42. Specifically, when a touch operation is executed on the touch-screen display 12 by the right hand, the touch operation is, in many cases, executed on the right side of the screen 40. In order to prevent the channel menu from being hidden by, e.g. the right hand touching the screen 40, the channel menu is disposed on the left side of the touch position 42.

When the first touch position 42 is near the left side of the screen 40, a channel menu, which is vertically arranged, may be disposed on the right side of the touch position 42. When the first touch position 42 is near the upper side, a channel menu, which is horizontally arranged, may be disposed on the lower side of the touch position 42.

In FIG. 16 and FIG. 17, for instance, the plural display areas, which form the channel menu, are linearly arranged. Alternatively, as shown in FIG. 18, the display areas may be displayed such that the display areas are arranged in a ring shape in a three-dimensional space. In the channel menu shown in FIG. 18, in accordance with a movement distance in the horizontal direction (X-axis direction) of the touch position 42, the display is altered such that the respective display areas move along the ring-shaped arrangement.

The arrangement of display areas is not limited to the linear shape or ring shape. Other arrangements may be adopted if the direction of movement of plural display areas can easily be recognized.

In the above description, the broadcast data reception module 27 is provided in the tablet computer 10, and the menu switching for switching TV broadcast, which is received by the broadcast data reception module 27, is described. Alternatively, contents, which are displayed on some other electronic apparatus, may be switched by an input operation using a channel menu on the tablet computer 10. Specifically, the tablet computer 10 is used as a remote controller of, for example, a TV apparatus, and the channel switching of the TV apparatus is controlled. In this case, the tablet computer 10 receives data of a plurality of selectable channels from the TV apparatus via the wireless LAN controller 26, displays the same channel menu as described above, based on the received data, and prompts the user to select a viewing-target channel. Then, the tablet computer 10 instructs the TV apparatus to effect switching to the viewing-target channel which has been selected by using the channel menu.

The above description is given of, by way of example, the case in which the channel of the TV broadcast is switched by using the channel menu. However, application is possible to the case of selecting, for example, various contents recorded in the SSD 25, such as data of moving pictures, still images or music. For example, when a plurality of moving picture files are recorded, display areas corresponding to the respective moving picture files are arranged, and a moving picture selection menu by the same format as the above-described channel menu is displayed. It is assumed that the input operation on the moving picture selection menu is executed in the same manner as with the above-described channel menu.

The above-described tablet computer 10 is configured to be equipped with the touch-screen display 12. Alternatively, such configuration may be adopted that the display 28 and the touch panel 29 are separately mounted.

The channel switching process of the embodiment can all be executed by a program. Thus, the same advantageous effects as with the present embodiment can easily be obtained simply by installing a channel switching program to various computers (personal computer, PDA (personal digital assistant), smartphone, car navigation system, etc.) which are equipped with the touch panel 29 (touch-screen display 12) as input devices, and executing the program.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a tablet;
a display;
an operation detection module configured to detect a first operation of releasing a touch on the tablet after moving a first touch position, and a second operation of releasing a touch on the tablet while moving a second touch position at a predetermined velocity or more;
a first menu display module configured to display a first menu on the display in accordance with the first touch position, the first menu comprising display areas displaying information of content, and to change display positions of the display areas in accordance with a movement distance of the first touch position;
a first instruction module configured to instruct, responding to the first operation of releasing the touch on the tablet, display of content corresponding to a first display area displayed at a first predetermined position in the first menu, among the display areas;
a second menu display module configured to display a second menu in accordance with the second touch position, and to change the display positions of the display areas in accordance with a movement velocity of the second touch position; and
a second instruction module configured to instruct display of content corresponding to a second display area displayed at a second predetermined position in the second menu, among the display areas.

2. The electronic apparatus of claim 1, wherein the first menu display module is configured to change the display positions of the display areas in accordance with a distance component of the movement distance in a direction in which the display positions of the display areas are changed.

3. The electronic apparatus of claim 1, wherein the second menu display module is configured to change display positions of the display areas in accordance with a velocity component of the movement velocity in a direction in which the display positions of the display areas are changed.

4. The electronic apparatus of claim 1, wherein the first menu display module is configured to display the first menu when a first set time passes since detection of the touch on the tablet, and
the second menu display module is configured to display the second menu when the first set time passes since the detection of the touch on the tablet.

5. The electronic apparatus of claim 4, wherein the first menu display module is configured to display the first menu when the first touch position moves before the first set time passes since the detection of the touch on the tablet, and
the second menu display module is configured to display the second menu when the second touch position moves before the first set time pass since the detection of the touch on the tablet.

6. The electronic apparatus of claim 1, wherein the first menu display module is configured to terminate the display of the first menu when a second set time passes since the first operation, and
the second menu display module is configured to terminate the display of the second menu when the second set time passes since the second operation.

7. The electronic apparatus of claim 6, wherein the first menu display module is configured not to terminate the display of the first menu, when the tablet is touched before the second set time passes, and
the second menu display module is configured not to terminate the display of the second menu, when the tablet is touched before the second set time passes.

8. The electronic apparatus of claim 1, wherein the first instruction module is configured not to instruct the display of the content corresponding to the first display area, when the display area, which was displayed at the first predetermined position before the display positions are changed by the first menu display module, is the same as the first display area, and
the second instruction module is configured not to instruct the display of the content corresponding to the second display area, when the display area, which was displayed at the second predetermined position before the display positions are changed by the second menu display module, is the same as the second display area.

9. The electronic apparatus of claim 1, wherein the operation detection module is configured to detect operation directions of the first operation and the second operation, and
the first menu display module and the second menu display module are configured to change the display positions of the display areas in the first and second menu in accordance with the operation directions.

10. The electronic apparatus of claim 1, wherein the first menu display module is configured to alter a display mode of the first display area displayed at the first predetermined position in the menu, and
the second menu display module is configured to alter a display mode of the second display area displayed at the second predetermined position in the menu.

11. The electronic apparatus of claim 1, wherein the first menu display module is configured to display the first menu near a first primary touch position on the tablet, and
the second menu display module is configured to display the second menu near a second primary touch position on the tablet.

12. The electronic apparatus of claim 1, further comprising a video display module configured to input broadcast program data of a channel selected from channels, and to display video, which corresponds to the broadcast program data, on the display,
wherein the first instruction module and the second instruction module are configured to instruct the video display module to switch the channel.

13. A switching method comprising:
detecting a first operation of releasing a touch on a tablet after moving a first touch position, and a second operation of releasing a touch on the tablet while moving a second touch position at a predetermined velocity or more;
displaying a first menu, on a display in accordance with the first touch position, the first menu comprising display areas displaying information of content, and changing display positions of the display areas in accordance with a movement distance of the first touch position;
instructing, responding to the first operation releasing the touch on the tablet, display of content corresponding to a first display area displayed at a first predetermined position in the first menu, among the display areas;
displaying the second menu in accordance with the second touch position, and to changing the display positions of the display areas in accordance with a movement velocity of the second touch position; and
instructing display of content corresponding to a second display area displayed at a second predetermined position in the second menu, among the display areas.

14. A computer-readable, non-transitory storage medium having stored thereon a switching program which is executable by a computer, the switching program controlling the computer to execute functions of:
detecting a first operation of releasing a touch on a tablet after moving a first touch position, and a second operation of releasing a touch on the tablet while moving a second touch position at a predetermined velocity or more;
displaying a first menu, on a display in accordance with the first touch position, the first menu comprising display areas displaying information of content, and changing display positions of the display areas in accordance with a movement distance of the first touch position;
instructing, responding to the first operation releasing the touch on the tablet, display of content corresponding to a first display area displayed at a first predetermined position in the first menu, among the display areas;
displaying the second menu in accordance with the second touch position, and to changing the display positions of the display areas in accordance with a movement velocity of the second touch position; and
instructing display of content corresponding to a second display area displayed at a second predetermined position in the second menu, among the display areas.
